(19) United States
(12) Patent Application Publication
(10) Pub. No.: US 2014/0041030 A1
(43) Pub. Date: Feb. 6, 2014

(54) SYSTEM FOR FINDING CODE IN A DATA FLOW

(71) Applicants: Justin David Call, Santa Clara, CA (US); Oscar Hunter Steele, III, Pompano Beach, FL (US)

(72) Inventors: Justin David Call, Santa Clara, CA (US); Oscar Hunter Steele, III, Pompano Beach, FL (US)

(73) Assignee: SHAPE SECURITY, INC, MENLO PARK, CA (US)

(21) Appl. No.: 14/110,659

(22) PCT Filed: Feb. 15, 2013
(86) PCT No.: PCT/US13/26516

§ 371 Date: Oct. 8, 2013

Related U.S. Application Data
(63) Continuation-in-part of application No. 13/527,025, filed on Jun. 19, 2012.
(60) Provisional application No. 61/600,145, filed on Feb. 17, 2012.

(51) Int. Cl. G06F 21/50

(52) U.S. Cl. CPC G06F 21/50
USPC 726/22

(57) ABSTRACT

A code finder system deployed as a software module, a web service or as part of a larger security system, identifies and processes well-formed code sequences. For a data flow that is expected to be free of executable or interpreted code, or free of one or more known styles of executable or interpreted code, the code finder system can protect participants in the communications network. Examples of payload carried by data flows that can be monitored include, but are not limited to, user input data provided as part of interacting with a web application, data files or entities, such as images or videos, and user input data provided as part of interacting with a desktop application.

### BACKGROUND

1. Field of the Invention

The present invention relates to systems for detection of undesired computer programs in network communications and other sources of input data.

2. Description of Related Art

Systems are vulnerable to malicious computer programs in a variety of settings. In theory, these vulnerabilities should be eliminated through disciplined coding practices, including routines for strong validation of system input. In practice, vulnerability-free software has been difficult to achieve.

In order for a vulnerability to be successfully exploited, code from the unwanted program must be present in system input. This code is sometimes referred to as shell code. Shell code consists of either directly executable instructions, such as would run on a microprocessor, or higher level programming language instructions suitable for interpretation.

Many attempts have been made to reliably identify attacks by unwanted programs. Methods include, but are not limited to, processes that rely on signatures for known attacks, on heuristics to recognize patterns similar to known attacks, on regular expressions that attempt to identify problematic code, on statistical analysis of system input to identify code, and on controlled execution of systems using unknown input to monitor application behavior in an instrumented environment. None of these strategies represents a completely reliable mechanism of identifying problematic input.

It is desirable therefore to provide technology to improve the security of data flows between data processing systems, without imposing undue burdens, such as delays, costs or increases in latency, on the users of the communication channels.

### SUMMARY

A code finder technology is provided for monitoring a data flow providing input data to a destination processing system, to detect fragments of well-formed code in the data flow. The payload of the data flow can be modified to disable or remove any detected fragments of well-formed code before it is passed out of the communication channel into a destination processing system. Alternatively, or in combination, the destination can be warned before well-formed code is delivered to the destination processing system.

The term “payload” in this context refers to all or part of the data carried by the data flow, and can exclude for example overhead of a transport protocol that is run to manage the data flow. Examples of payload carried by data flows that can be monitored include, but are not limited to, user input data provided as part of interacting with a web application, data files or entities, such as images or videos, and user input data provided as part of interacting with a desktop application.

The data flow can be scanned to detect tokens that represent candidate code elements, where a token can consist of a character or a character sequence used to define executable lines of code. The detected token can be parsed to identify sequences of candidate code elements which could constitute fragments of well-formed code.

A data flow between network destinations can be executed according to a transport protocol which is configured to deliver data entities, values for parameters, user input and other forms of payload data from one platform to another. A data flow that comprises user input supplied at a data processing system, can include contents of a portable storage medium, a data flow provided using a keyboard or a touch screen, and other forms of user input.

Well-formed code can be specified by syntax graphs, and sequences of tokens can be classified as a fragment of well-formed code by satisfying one of the syntax graphs. The syntax graphs can be configured as searchable data structures, using for example a node-link structure. The system can monitor payloads for code expressed in any one of a plurality of computer programming languages, using for example multiple syntax graphs, each of which can encode a syntax for well-formed code according to a particular computer programming language. Data structures other than syntax graphs can be used in some embodiments, such as pushdown machines.

Computer programming languages, and things which can include fragments and be represented as a context free grammar, can be monitored as described herein, including low level programming languages, such as languages known as binary executable code or machine executable code, and higher level programming languages, including languages which can be compiled or otherwise processed for translation to lower level programming languages.

Other aspects and advantages of the present technology can be seen on review of the drawings, the detailed description and the claims, which follow.

### BRIEF DESCRIPTION OF THE DRAWINGS

FIG. 1 is a diagram representing a communication network including code finder systems.

FIG. 2 is a block diagram of a code finder system.

FIG. 3 is a flow chart illustrating logic processes executed by an embodiment of a code finder system.

FIG. 4 is a flow chart illustrating logic processes executed by a system scanning a data flow to detect code sequences that satisfy a syntax graph for a computer programming language.

FIG. 5 is a block diagram of a system for creating syntax graphs for computer programming languages.

FIG. 6 is an abbreviated LR grammar for a subset of the SQL Select statement.

FIG. 7 is the augmented LR grammar generated for the grammar in FIG. 6.

FIG. 8 is a list of the symbol mappings between FIG. 6 and FIG. 7.

FIG. 9A is the fragment detector Action table for the grammar in FIG. 7.

FIG. 9B is the fragment detector Goto table for the grammar in FIG. 7.

FIG. 10 shows a sample data stream and the corresponding token sequences derived for processing by a fragment detector.

FIG. 11 is a table of the initial fragment detector configurations corresponding to the token sequences in FIG. 10.

FIG. 12 is a table showing the evolution of states as a fragment detector processes initial configuration 1 from FIG. 11.

FIG. 13 is a flow chart illustrating logic processes executed by a system scanning a data flow to detect code sequences that satisfy a syntax graph for a computer programming language in an alternate embodiment than the one in FIG. 4.

FIG. 14 is a block diagram representing a network device including code finder resources.

### DETAILED DESCRIPTION

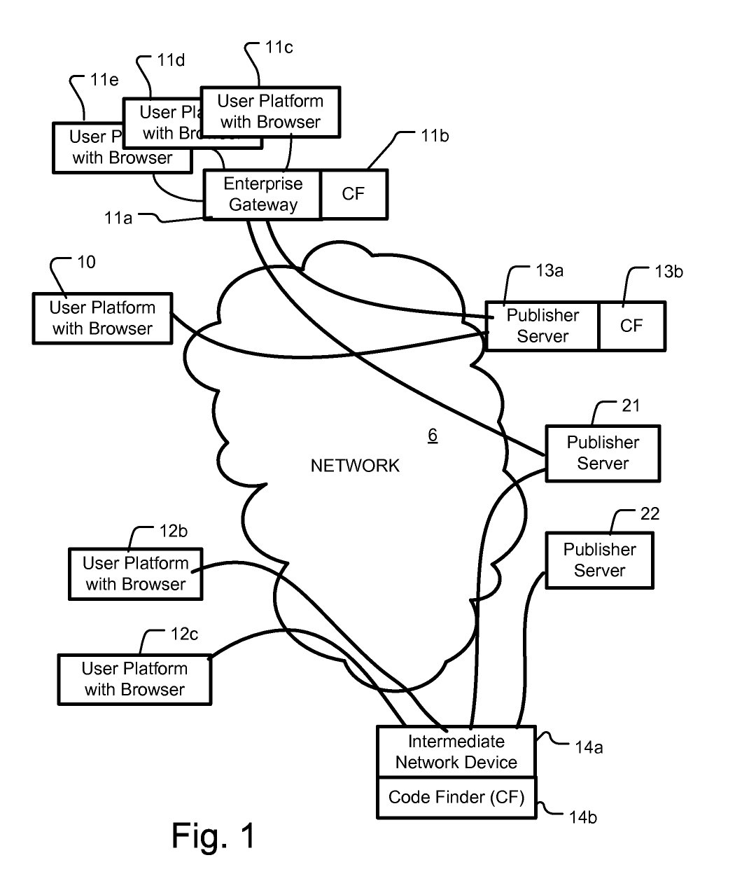

A detailed description of embodiments of the present invention is provided with reference to the FIGS. 1-14.

FIG. 1 is a contextual diagram illustrating a network environment 6 employing code finder technology which, for example, is implemented by executing processes in an intermediate network device, a network destination device, a security appliance, enterprise gateway device or other network elements having data processing resources positioned in a manner that allows monitoring of a data flow on a communication channel before delivery of the data flow to the destination vulnerable to undesired code in the payload. The network environment 6 can comprise the Internet, other wide area network configurations, local area network configurations and so on. The network configuration 6 can include for example a broadband backbone bringing together a wide variety of network physical layer protocols and higher layer protocols. One or more layers of transfer protocols are used for transferring payloads across communication channels between devices. Such protocols can be HTTP, HTTPS, SPDY, TCP/IP, FTP and the like. The technology described herein can be deployed in network configurations other than the Internet 6 as well. A payload in a transfer protocol can include entities being shared, such as text files, digital sample streams, image files, video files, webpages, and the like, as well as other user input, like parameters for identifying dynamic webpages, and parameters for search queries.

FIG. 1 shows some alternative configurations in which the code finder technology described herein can be deployed. In one configuration, user platform 10 is connected via a communication channel, such as an HTTP session linking via a TCP/IP socket, to a publisher server 13a executing on a data processing system. The server 13a can host a website for example which exchanges data with the user platform 10, which can comprise a data processing device with a browser and supporting network protocol stack programs, or other programs that enable it to establish a communication channel on the network. The publisher server 13a includes a module 13b, which can comprise a loadable web server extension for example, which executes the code finder processes on payload incoming from user platform 10. The code finder in module 13b can be configured to monitor data flows at the server 13a provided via channels other than the network, such as keyboards, touch screens, portable storage media, etc.

In another configuration, an enterprise gateway 11a, configured for example as a security appliance, is connected via a communication channel to the publisher server 13a, as well as other publisher servers (e.g. 21) in the network environment 6. The enterprise gateway 11a acts as a network intermediate device between user platforms 11c, 11d, 11e and the broader network. In this example, the enterprise gateway 11a includes a module 11b which executes the code finder processes on payload traversing the gateway 11a.

In yet another configuration, an intermediate network device 14a, configured for example as a proxy server, includes a module 14b that executes the code finder processes on payloads which traverse via communication channels between user platforms 12b, 12c and publisher servers 21, 22 in the network.

In yet other configurations, a code finder module (not shown) can be configured to monitor data flows at a portable computing device, personal computer or workstation for example, that are provided via channels other than the network, such as keyboards, touch screens, portable storage media, audio channels, etc. One such data flow can comprise input data provided by a user for a desktop application, for example.

Operation of the code finder can be understood with respect to the following example, based on the REQUEST message type of the HTTP protocol. In this example, the data flow can include a GET request received at a code finder module, as follows:

GET/form.php?param1=%E2%80%98%20AND%20%E2%80%981%E2%80%9
9%20NOT%20NULL%0Aotherdata&param2=okdata HTTP 1.1
HOST example.com
User-Agent: Agent String

This request seeks processing of a php form using first and second parameters, param1 and param2, from a destination “example.com.” The request also includes the user agent string associated with the session.

The payload in this example includes the data values for param1 and param2, and potentially the host URL and the agent string from the user. A portion of the payload is “escape” encoded, and must be decoded by applying an “un-escape” process, prior to scanning for well-formed code. After the decoding, the GET request includes the following:

GET /form.php?param1=‘ AND ‘!’ NOT NULLotherdata&param2=okdata
HTTP 1.1
HOST example.com
User-Agent: Agent String

The code finder can identify a well-formed code sequence, which consists in this example of the fragment: ‘AND ‘1’ NOT NULL. The code finder can then modify the data flow by removing the identified well-formed code fragment, resulting in the following:

GET /form.php?param1=otherdata&param2=okdata HTTP 1.1
HOST example.com
User-Agent: Agent String

This is the HTTP Request case, originating from a user platform. As mentioned above, it is also possible in some cases to apply the same process to content returned by a webserver which acts as a publisher of a website or other content, protecting the user platforms which utilize the content. For example, the enterprise gateway 11a can be configured to protect the user platforms 11c, 11d, 11e from publishers and other sources of payload in the broader network environment. Also, the transfer protocol level at which the monitoring is executed can be lower or higher in the protocol stack, as suits a particular implementation.

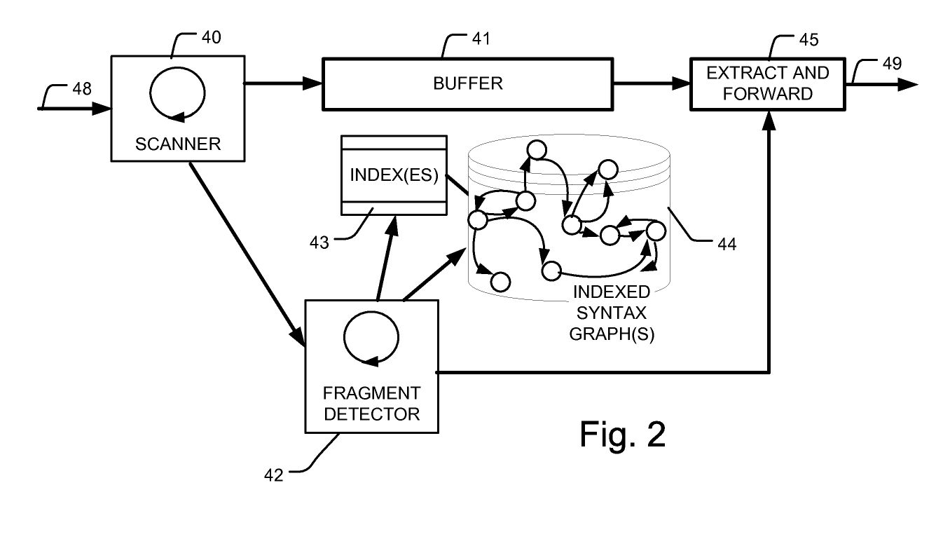

FIG. 2 illustrates components of an implementation of code finder technology. A data flow is received via a communication channel 48. The data flow is applied to a scanner 40 and to a buffer 41. The scanner 40 and buffer 41 are shown in series only for the purposes of the diagram. Other configurations could be used, such as for example, arranging the scanner 40 and buffer 41 in parallel, and arranging the buffer 41 in advance of the scanner 40. The scanner 40 scans the payload for tokens that can represent candidate code elements. In some embodiments, the scanner 40 can include logic to translate data in the data flow into characters according to known character sets, such as ASCII character sets, that can be used to express a computer programming language. The candidate code elements are delivered to a fragment detector 42 that contains syntax mapping logic, which is a parser configured to detect fragments. The fragment detector 42 is coupled to a structure such as an indexed syntax graph store 44 containing, or from which can be derived, all possible valid sequences of tokens in a computer programming language. The store 44 includes indexed syntax graphs for at least one, and preferably a plurality of, computer programming languages. Indexes 43 are included in the store 44, which map hard tokens to their corresponding syntax graphs. The fragment detector 42 is configured recognize sequences that include fragments of code that can be present a threat to a receiving platform The syntax graphs in the store are configured to recognize sequences that include fragments of code that can present a threat to a receiving platform. Such fragments are defined according to the needs of a particular implementation. In one example, a sequence can be classified as a well-formed fragment to be processed if it meets any one of a number of preset rules. For example, a set of preset rules can include whether the sequence is a valid expression or statement in the subject programming language, whether the sequence includes a threshold number of tokens, and whether the sequence satisfies empirical guidelines.

In alternative configurations, the syntax mapping logic could be implemented using other data structures, such as a parse tree, with a lookup table for hard tokens. Also, the syntax mapping logic could be implemented using pushdown machines, which comprise finite state machines that accept input tokens and apply them to pending stacks of tokens according to the syntax rules. A system utilizing pushdown machines for syntax mapping could maintain instances of the pushdown machines for each language. An index in such systems could be employed to assign new hard tokens to the instances of pushdown machines in condition to accept a hard token, including pushdown machines having empty stacks, associated with the programming languages being monitored.

Upon identifying a well-formed code sequence that can be classified as a fragment, the parser notifies logic 45 which processes the identified sequence by, for example, extracting the identified sequence from the payload in the buffer 41, and forwarding the modified payload on communication channel 49 toward its destination. The scanner 40 and parser 42 can operate on system input at runtime.

In an alternative, the logic 45 can return information about the identified sequences to the destination, in advance of or with the payload, so that the problematic input may be appropriately handled at the destination system. Also, in some embodiments, the identified sequences can be processed in other ways, including logging the identified sequences for later analysis, flagging identified sequences in network configuration control messages, identifying the sources of the identified sequences, and so on.

In one example configuration, the scanner 40 reads a stream of input payload, and converts it into tokens. Two types of tokens are identified. One type is hard tokens. Hard tokens are keywords or punctuation found in a set of programming languages to be recognized by the code finder. A list of known hard tokens is created during creation of the syntax graph for each programming language. Thus, a hard token is a token that appears in the index for one or more programming languages being monitored. Soft tokens are collections of characters that are not hard tokens. Tokens in a payload being scanned can be individually identified for example by identifying boundaries such as whitespace or other non-punctuation characters. In some examples, the parser 42 can accumulate a threshold number of sequential soft tokens before walking the syntax graph or graphs for matches. In some examples, the soft tokens consist of all terminal symbols in the grammar of the programming languages that are not identified as hard tokens and a special soft token called the unknown token is generated for each programming language which represents lexemes that have no corresponding token in the language.

Examples of hard tokens and soft tokens can be understood from the following example of a payload in the form of a simple Structured Query Language (SQL) query:

SELECT * FROM auth_user WHERE username = ‘admin’ AND
password = sha1( ‘passwd’ )

In this example SQL query, a hard token index for SQL could identify 14 hard tokens, including the following:

SELECT
*
FROM
WHERE
=
′
′
AND
=
(
′
′
)
;

There are six soft tokens in this example SQL query, including the following:

auth_user
username
admin
password
sha1
passwd

In one example implementation of the parser 42, the parser 42 consults an indexed syntax graph in the store 44. The indexed syntax graph store includes graphs, that can be configured as hierarchical node-link structures for example, which characterize well-formed code sequences encoded by a set of specified recognizable programming languages. To facilitate recognition of partial statements or expressions, and to allow for flexibility of the beginning of sequences, hard tokens are preferably indexed to allow immediate lookup.

Potentially using additional input from the payload, the fragment detector finds the longest possible path through the graph that matches the input for each programming language being monitored. The fragment detector need not attempt to differentiate between ‘good’ and ‘bad’ code, but rather can attempt to identify sequences of tokens that match valid paths in the syntax graphs and the detection parameters of the fragment detector. Beginning with the first non-matching token, information about the result can be returned. Regardless of whether a path was found, processing continues with the next hard token to ensure all code fragments are identified.

A code finder system need not attempt to recognize input as well-formed statements or expressions. A code finder system can merely identify sequences that meet the parameters of the syntax graphs. This is advantageous because shell code, or other unwanted code in a payload, may be incomplete and rely on the existence of prior instructions or other state present in the targeted system. For example, injection attacks against web applications commonly consist of SQL instructions that unexpectedly terminate an application's original SQL statement and add additional commands.

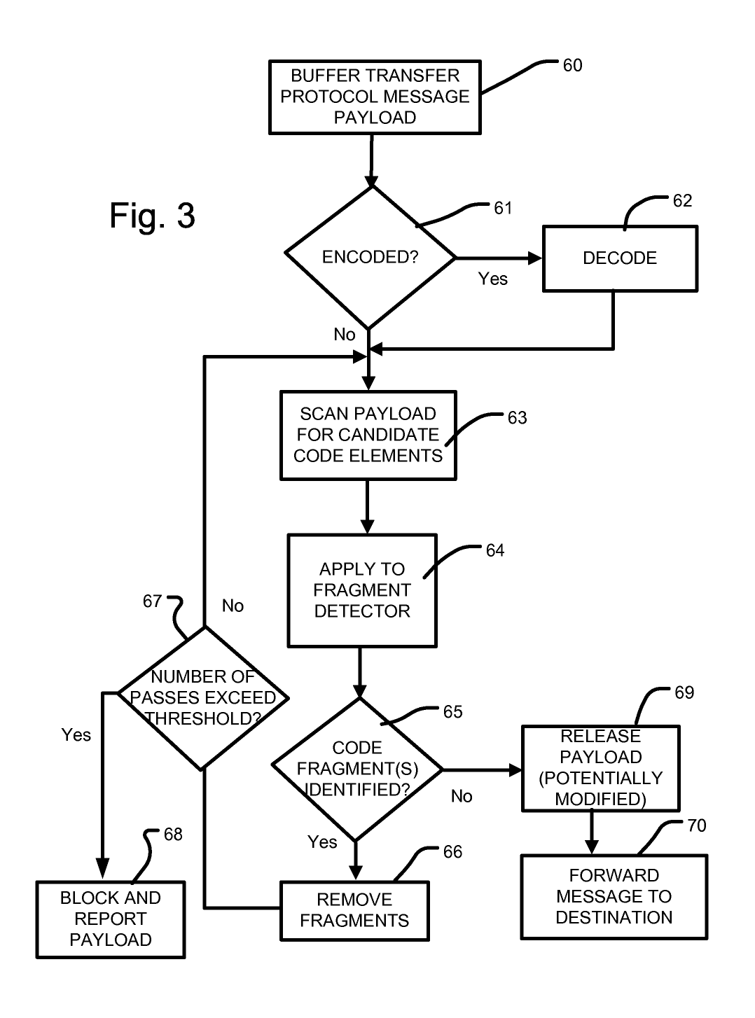

FIG. 3 is a flowchart of an example of basic logic which can be executed by a system configured as illustrated in FIG. 2. In a first step, the data flow, including a payload, from a transfer protocol message is buffered (60). The logic, preferably identifies the payload in the data flow, and determines whether the payload is encoded, such as by “escape” encoding (61). If it is encoded, then the logic applies the decode function (62). If the payload is not encoded, or after decoding, the logic scans the payload to select candidate code elements, and potentially classifies the candidate code elements as hard tokens (i.e., tokens listed in the indexes for the set of monitored programming languages) and soft tokens (63). The tokens are applied to the parser (64), which attempts to identify well-formed code fragments. The logic determines whether any well-formed code fragments have been identified (65). If at step 65, a well-formed code fragment is identified, then the logic removes the identified fragment (66), and performs another pass through the payload by looping to step 63, with the modified payload, provided that a threshold number of passes has not already been executed (67). In preferred systems, at least two passes are executed (the threshold of block 67 is at least two) to detect nested code fragments, or other arrangements of code fragments that could be implemented to avoid detection in a single pass, or a small number of passes. If the number of passes exceeds the threshold, then the payload can be blocked and reported (68), or processed in other ways.

If at step 65, no well-formed code fragments are identified, then the payload (potentially modified) can be released (69) and forwarded to processing resources at its destination (70).

The processing of the fragments can include removing them from the payload as mentioned above. In other embodiments, the fragments can be altered or modified in some manner to disable them while preserving the byte counts and the like needed by the transport protocol. Alternatively, the processing of the sequences can comprise composing warning flags or messages to be associated with a payload and forwarded to the destination or a network management system, in a manner that results in a warning to the destination before the payload is delivered to vulnerable processing resources at the destination where the code sequence can be executed. For example, a warning can be intercepted in the communication stack of a system hosting a destination process before delivery of the payload to locations in the data processing system hosting the destination process, at which the code sequence can be executed or combined with executable code, and thereby do harm to processes, including the destination process, executing in the system.

The order of the steps shown in FIG. 3 can be modified, and some steps can be executed in parallel, as suits a particular implementation.

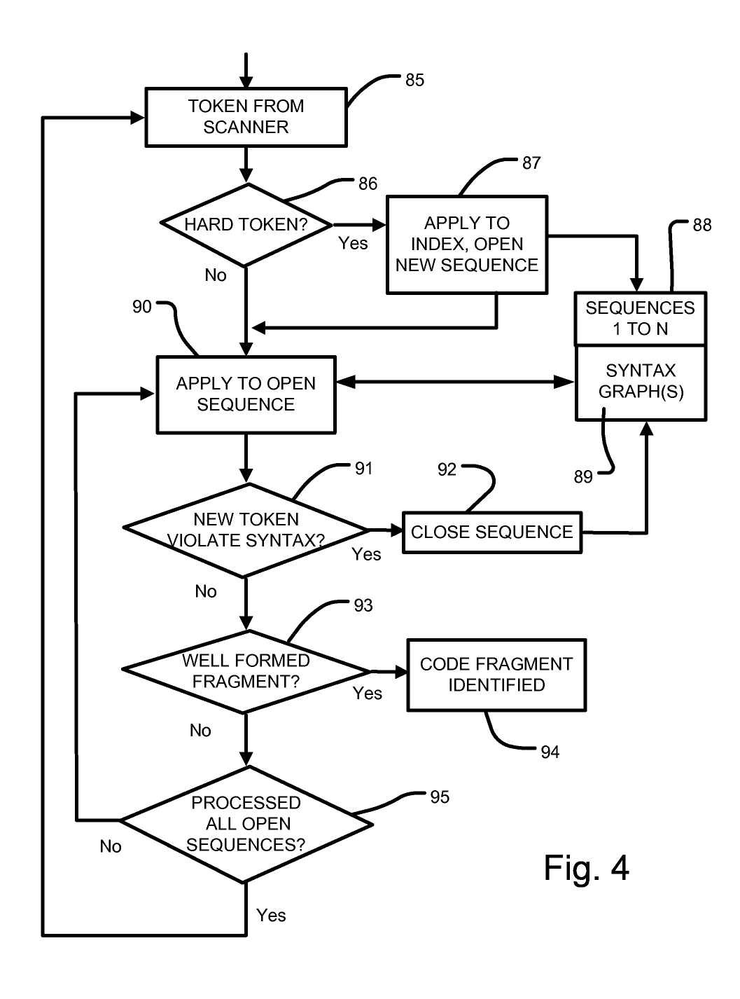

FIG. 4 illustrates one process for walking an indexed syntax graph, which can be executed by the parser, as modified for fragment detection. Beginning, for example, at step 64 in FIG. 3, the parser can receive a token from the scanner (65). The process determines whether the received token is a hard token (86). If it is a hard token, then it is applied to the index or indices available to the fragment detector, and a new sequence is opened for each state in any syntax graph in which there is a match on the index (87). The logic stores a set of sequences in a data structure (88), the data structure holding sequences in process for identification of well-formed code fragments, including any new sequences opened in step 87. After processing hard tokens in step 87, or if the token was not a hard token at step 86, then the logic applies the token to open sequences stored in the data structure 88 associated with the syntax graphs (89). The logic can determine for each open sequence whether the new token violates the syntax (91). If it does violate the syntax without having resulted in identification of a well-formed code fragment, then the sequence can be closed (92). If the new token does not violate the syntax for the open sequence, then the logic determines whether the open sequence with the new token qualifies as a well-formed fragment (93). If a well-formed fragment is identified, then the well-formed fragments can be reported to logic for processing the payload as mentioned above (94). If a well-formed fragment has not been identified at step 93, then the logic determines whether all of the open sequences have been processed with the new token (95). If there are additional open sequences in the data structure 88, then the process applies the token to the next open sequence at block 90. If all the open sequences have been processed, then the logic processes a next token at block 85.

The order of the steps shown in FIG. 4 can be modified, and some steps can be executed in parallel, as suits a particular implementation.

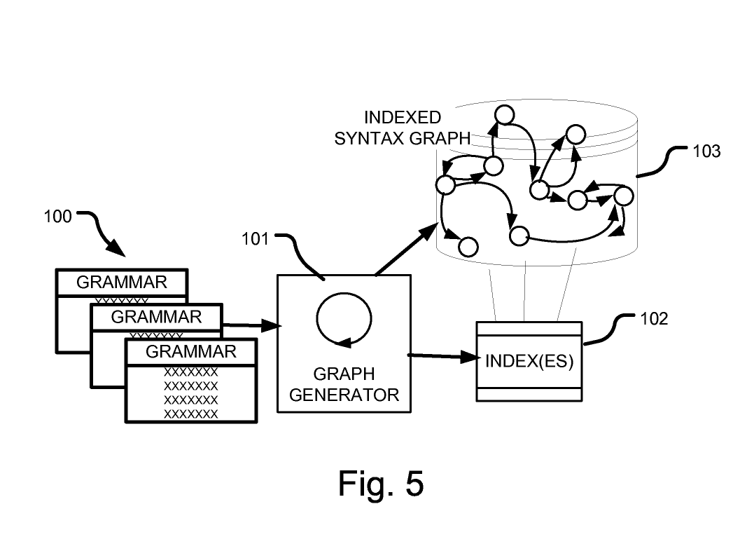

FIG. 5 is a simplified diagram of a graph generator system for generating indexed syntax graphs for programming languages, which can be used in a code finder system. In this example, each input programming language is specified by a grammar 100 such as a Backus-Naur Form BNF or Extended Backus-Naur Form EBNF syntax specification, or any other suitable language capable of defining a grammar. Using the input grammars, the graph generator produces a syntax graph for each grammar. A syntax graph encodes the data necessary to determine, given a hard token, all possible valid statements which contain the hard token according to the corresponding grammar. Indexes into the resulting data structure that reference hard tokens are retained for later use. Thus, the graph generator logic 101 can traverse a grammar, identifying and creating a list of hard tokens for the programming language. Also, the graph generator logic 101 produces a data structure, such as a node-link data structure arranged as a directed graph that can be walked by a parser, and stores the data structure in the indexed syntax graph store 103. Then, the list of hard tokens is mapped to corresponding nodes in the graph, forming the index 102. In some embodiments, nodes in the directed graph represent one or more tokens of the subject programming language, which are compliant with the specified grammar A transition from one node to the next can be taken upon receipt of a next token, provided that there is a valid transition from the current node based on that next token. The nodes in the directed graph can be labeled as corresponding to well-formed code fragments. Also, nodes at the leaves in the directed graph for which there is no valid transition based on a next token can necessarily correspond to well-formed code fragments. In other embodiments, nodes in the directed graph represent all the valid states a parser for the grammar could be in during a parse and the links between nodes represent the valid transitions from one state to another based on the next token to be processed. The index maps each hard token to every state in which there is a valid transition to another state if the next token parsed is the hard token.

A sequence of tokens in a data flow can include a well-formed fragment beginning anywhere in the graph. A path in the graph representing any sequence including more than two transitions, for example, can be identified as an open sequence, when selected using a hard token.

The grammar for a language defines the rules by which well formed fragments and valid sentences (sequences of tokens) are formed. Given a specific token, identifying the tokens that can legally follow it is usually dependent the sequences of tokens that preceded it. In the case of code fragment detection, these preceding tokens are not known. Thus to detect well formed code fragments, the code detector parser determines, according to the rules for a given grammar, the viable prefixes for any stream of tokens found in the input starting with a hard token. That is, what sequences of tokens, if they immediately preceded the token stream starting with the hard token, would result in a valid parse of sufficient length to meet the detection rules. The indexed syntax graph encapsulates the knowledge required for the parser to calculate those prefixes given a hard token.

Algorithms for generating parsers can be used in the generation of indexed syntax graphs. For example, algorithms in the LR family of parsers (e.g. SLR, LALR, LR) define two tables, called the action and goto tables. These tables in combination contain information necessary to determine viable prefixes for a given token and are indexed by token. A code fragment detection parser can be built using the LR tables for a given grammar, as the indexed syntax graph. Also, algorithms for constructing GLR parsers also generates data structures that are sufficient for use as the indexed syntax graph.

Another common type of parser used for computer languages are LL parsers. LL parsers are simpler to implement but can only be used for a subset of the languages that LR parsers can handle (e.g. LL can not be used for C++). With LL parsers, part of the knowledge required to determine viable prefixes is encoded directly as executable code in the parser rather than a traversable data structure. A modified LL parser generator algorithm can be used to generate an indexed syntax graph. Indeed, a variety of parsing algorithms can be used to produce a suitable indexed syntax graph, or can be modified to do so.

Graph generation can be performed offline. The graph generator makes use of structured grammars for the desired recognizable programming languages. Given the specialized nature of this parsing application, ambiguity in the grammar can be tolerated. This makes it possible to represent programming languages which may otherwise be impossible to parse.

In one embodiment, the indexed syntax graph and index are based on canonical LR(1) parsing tables (See, Alfred V. Aho, Monica S. Lam, Ravi Sethi, Jeffrey D. Ullman. COMPILERS: PRINCIPLES, TECHNIQUES & TOOLS, 2nd ed., Addison-Wesley, 2007, p. 265 (known sometimes as the “Dragon Book”)) with the addition of support for ambiguous grammars by allowing action table entries to contain multiple actions.

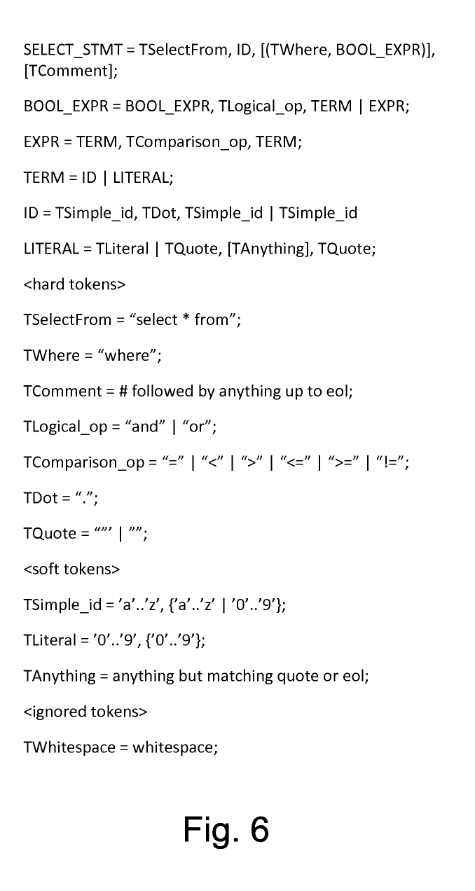

FIG. 6 shows an abbreviated grammar for a subset of the SQL select statement. The entire SQL grammar is not used for the purpose of this description, and the grammar that is used is abbreviated to keep the size of the figures reasonable. In this embodiment the grammar is converted to an LR augmented grammar that is additionally extended by the addition of a special token called the unknown token, which we will represent as the terminal symbol “m.” The unknown token is generated such that it matches all lexemes that are not valid tokens in the source grammar. In this embodiment the scanner is aware of the unknown token for each grammar and the token streams it generates contain the unknown token as appropriate.

For brevity a subset of the notational conventions for grammars are adopted from the Dragon Book (Aho, et al., supra, p198-199). The following notational conventions for grammars will be used in subsequent text and figures:

1. These symbols are terminals:
a. Lowercase letters early in the alphabet, such as a, b, c.
b. Operator symbols such as +, *, and so on.
c. Punctuation symbols such as parentheses, comma, and so on.
d. The digits 0, 1, . . . , 9.

2. These symbols are nonterminals:
a. Uppercase letters early in the alphabet, such as A, B, C.
b. The letter S, which, when it appears, is usually the start symbol.

3. Uppercase letters late in the alphabet, such as X, Y, Z, represent grammar symbols; that is, either nonterminals or terminals.

4. Lowercase letters late in the alphabet, chiefly u, v, . . . , z, represent (possibly empty) strings of terminals.

5. Lowercase Greek letters, α, β, γ for example, represent (possibly empty) strings of grammar symbols. Thus, a generic production can be written as A→α, where A is the head and α the body.

6 A set of productions A→α₁, A→α₂, . . . , A→αₖ with a common head A (call them A productions), may be written A→α₁|α₂| . . . , αₖ. Call α₁, α₂, . . . , αₖ the alternatives for A.

7. Unless stated otherwise, the head of the first production is the start symbol.

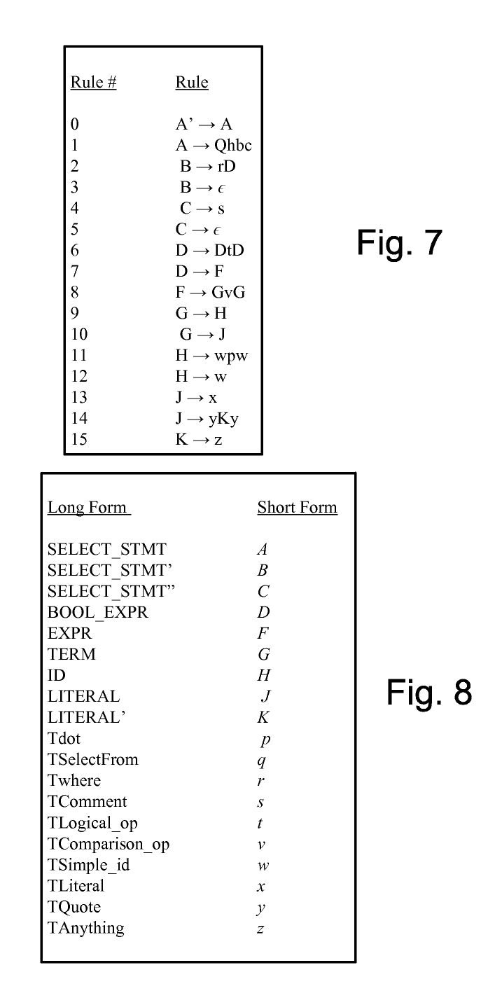

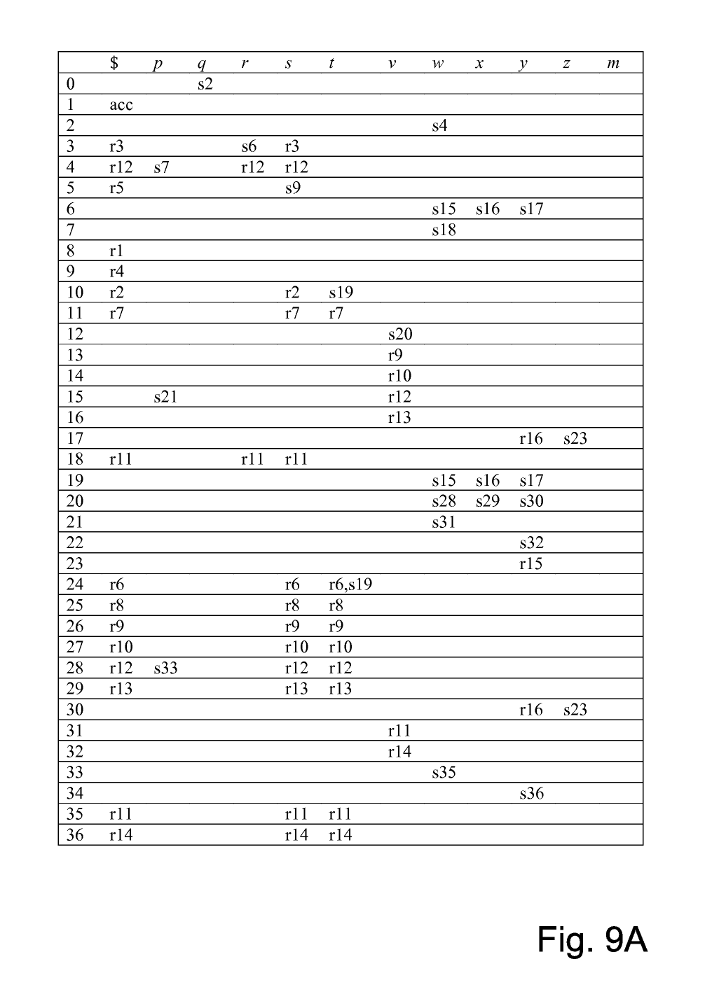

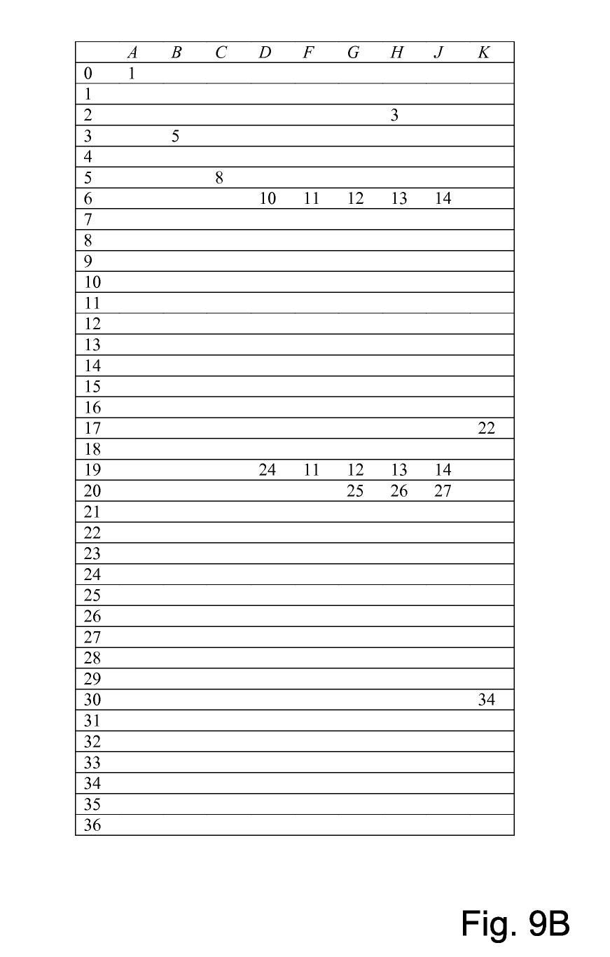

FIG. 7 shows the production rules of the augmented grammar from FIG. 6 after making the substitutions as shown in FIG. 8. FIG. 9A-9B shows the combined syntax graph and index generated by this embodiment. FIG. 9A is an “Action” table, and FIG. 9B is a “GOTO” table.

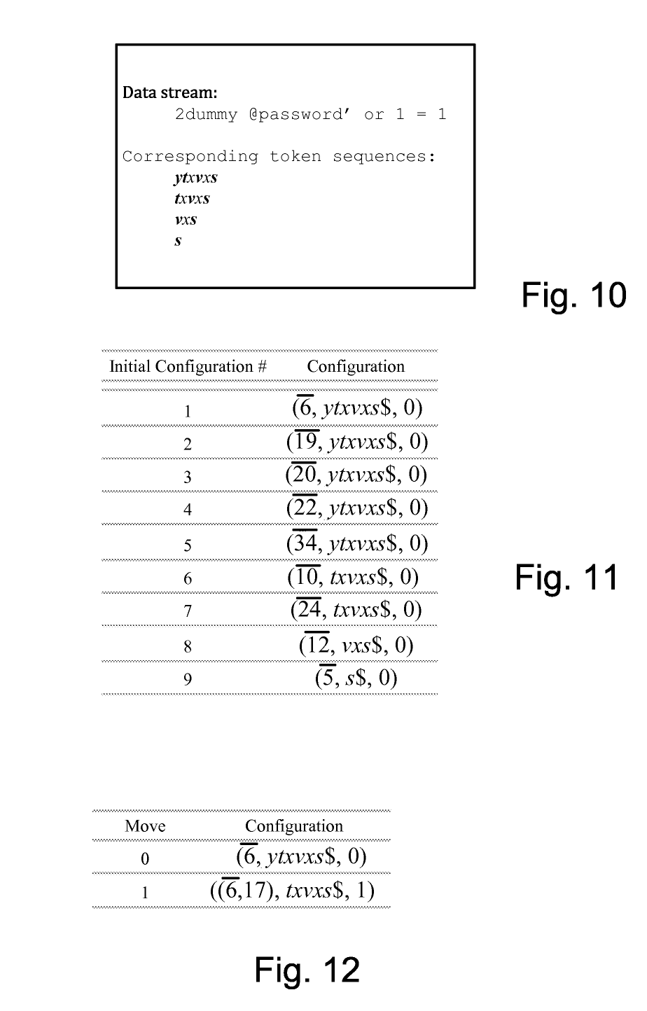

FIG. 10 shows a data stream and the resultant token sequences, with the hard tokens in bold, that the scanner produces for examination.

In this embodiment the fragment detector is based on a pushdown machine, which can be characterized by the “Action” table in FIG. 9A and the “GOTO” table in FIG. 9B. It helps to have a notation representing the complete state of the fragment detector. In this embodiment, a configuration consists of the triple (sⱼsⱼ₊₁ . . . sₘ, aᵢaᵢ₊₁ . . . aₙ$, k). The first component (sⱼsⱼ₊₁ . . . Sₘ) is the states of the configuration that make up stack contents (top of stack on the right), the second component (aᵢaᵢ₊₁ . . . aₙ$) is the remainder of the token sequence yet to be processed, and the third component “k” is the length of the valid fragment so far identified. There can be many configurations being processed for a given token stream. A configuration is a data structure maintained for each “sequence” as the term “sequence” is used with reference to FIG. 4. This differs from the configurations for a pushdown machine for a parser looking for complete statements or expressions in several ways, including the inclusion of the length of the valid fragment identified, the stack need not contain the start state of the grammar, and the inclusion of both presumed (denoted by a bar over the state) and actual states in the stack. A presumed state is a state where there is a valid transition to another state based on the current token, and thus defines a set of viable prefixes.

The fragment detector constructs the initial set of configurations by indexing into the syntax graph selecting the columns (e.g. in the go to table of FIG. 9A) for each of the hard tokens that appear as the first token in the set of token sequences. Each such column is scanned to identify the states (leftmost column) that contain a shift action in these columns and a configuration is generated for each state (e.g. using the action table in FIG. 9A) as these states represent all valid states where the next valid token is the hard token in question. For example, FIG. 11 shows the complete set of initial configurations generated based on the sequences in FIG. 10. The stack for all initial configurations contains a presumed state. Here for token y, the go to table in FIG. 9A has shift actions in states 6, 19, 20, 22 and 34. Thus, there are five initial configurations that can be presumed for the token y. The token t has shift actions in states 10 and 24. The token v has a shift action in state 12. The token s has a shift action in state 5. As an optimization some embodiments may remove initial configurations where the length of the token stream to be processed is too short to match the detection threshold.

The pushdown machine executes, in series or parallel, starting with all of the initial configurations, adding new configurations as necessary, until every active configuration reaches an error or finish state. If any of the final configurations have processed sufficient tokens according to the fragment detection rule applied, a detection event is reported based on the largest number of tokens processed in the set of final configurations. As an optimization, some embodiments may report a detection as soon as one configuration exists where a sufficient number of tokens have been processed.

The operation of the fragment detector in this embodiment differs from a typical pushdown machine significantly regarding reduce operations. For example, processing of initial configuration 5 (presumed state 34) encounters a reduce action after the first move as shown in FIG. 9A (Action table entry at state 34 for token y, causes shift to state 36, where token t calls for reduction according to production rule 14). Reducing using production 14 (J→yKy) requires the configuration to have 4 states on the stack (so that there is one state left on the stack after the reduce action is performed). The fragment detector extends the bottom of the stack by finding all viable prefix states to the state currently on the bottom of the stack. In this example, only one state performs a shift or goto to state 34 so the current configuration is replaced with a new one that is identical but has state 30 added to the bottom of the stack, ((30, 34, 36), txvxs$, 1) and processing continues.

If more than one viable prefix state exists, the current configuration is replaced by a set of new configurations, one for each distinct viable prefix state. The fragment detector repeats this process until the relevant configurations are all of sufficient length to permit the reduce operation to be performed. In this example, it only finds one viable prefix resulting in the new configuration ((20, 30, 34, 36), txvxs$, 1) and it performs the reduction yielding the new configuration ((20, 27), txvxs$, 1) and processing continues.

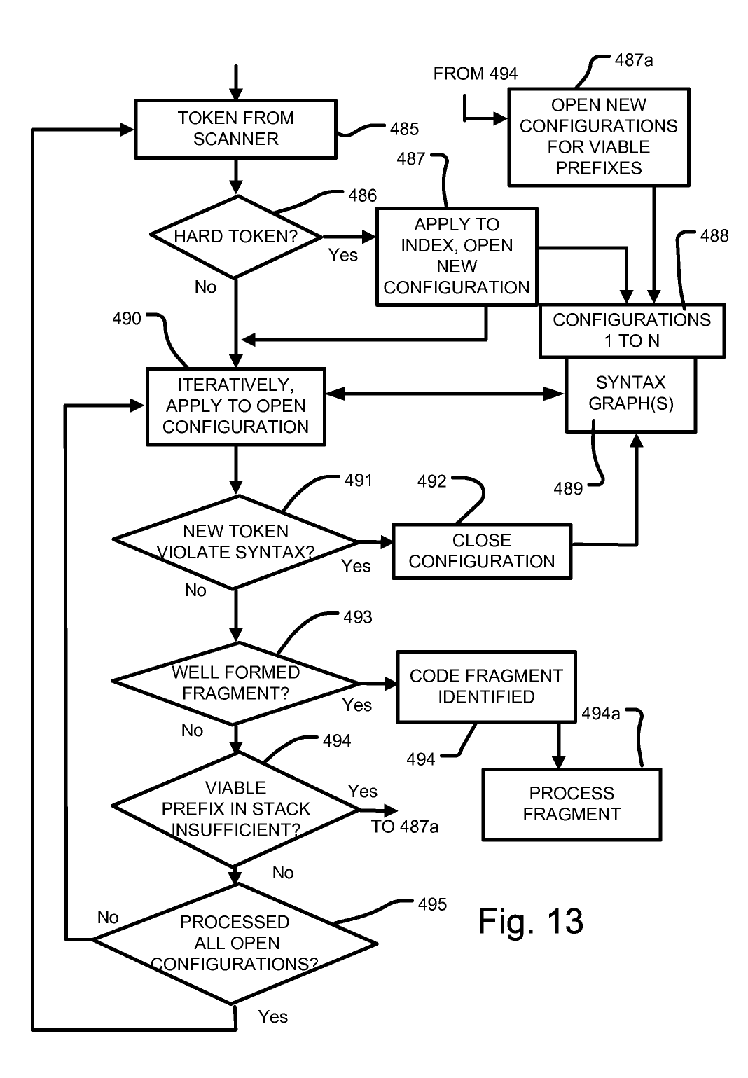

Embodiments may process configurations sequentially or in parallel. FIG. 13 illustrates one process for walking an indexed syntax graph in an alternative embodiment. Beginning, for example, at step 64 in FIG. 3, the fragment detector can receive a token from the scanner (485). The process determines whether the received token is a hard token (486). If it is a hard token, then it is applied to the index or indices available to the fragment detector, and a new configuration is opened for each state in any syntax graph in which there is a match on the index (487). Optionally, all known tokens can be processed by the fragment detector, which can be configured to skip unknown tokens. The logic stores configurations for a set of sequences in a data structure (488), the data structure holding sequences in process for identification of well-formed code fragments, including any new sequences opened in steps 487 and 487a. After processing hard tokens in step 487, 487a or if the token was not a hard token at step 486, then the logic iteratively applies the token to open configurations (490) stored in the data structure 488 associated with the syntax graphs (489). In an alternative embodiment, the configurations can be processed in parallel all together, or in groups. The logic can determine for each open configuration whether the new token violates the syntax (491). For the example shown in FIGS. 9A and 9b, the logic encounters a shift, a reduce, an accept or an error. If an accept is encountered, then the configuration identifies a fragment. If not, then the process continues. Next, if a reduce is encountered the it is determined whether the if the length of the stack in the configuration is large enough to perform the reduce (494). In determining if the new token violates the syntax for the open configuration, the logic may require the length of the stack in the configuration to be larger than it currently is. If this is the case then the logic (487a) consults the syntax graph to determine all viable prefixes of sufficient length that lead to the current state represented by the configuration and replaces the current configuration with the set of configurations corresponding to the newly determined viable prefixes as described in paragraphs [0078] and [0079], and processing continues at block 490. If it does violate the syntax without having resulted in identification of a well-formed code fragment, then the configuration can be closed (492). If the new token does not violate the syntax for the open configuration, then the logic determines whether the open configuration with the new token qualifies as a well-formed fragment (493). If a well-formed fragment is identified, then the well-formed fragments can be reported to logic for processing the payload as mentioned above (494, 494a). If a well-formed fragment has not been identified at step 493, then the logic determines whether all of the open sequences have been processed with the new token (495). If there are additional open configurations in the data structure 488, then the process applies the token to the next open configuration at block 490. If all the open configurations have been processed, then the logic processes a next token at block 485.

The order of the steps shown in FIG. 13 can be modified, and some steps can be executed in parallel, as suits a particular implementation.

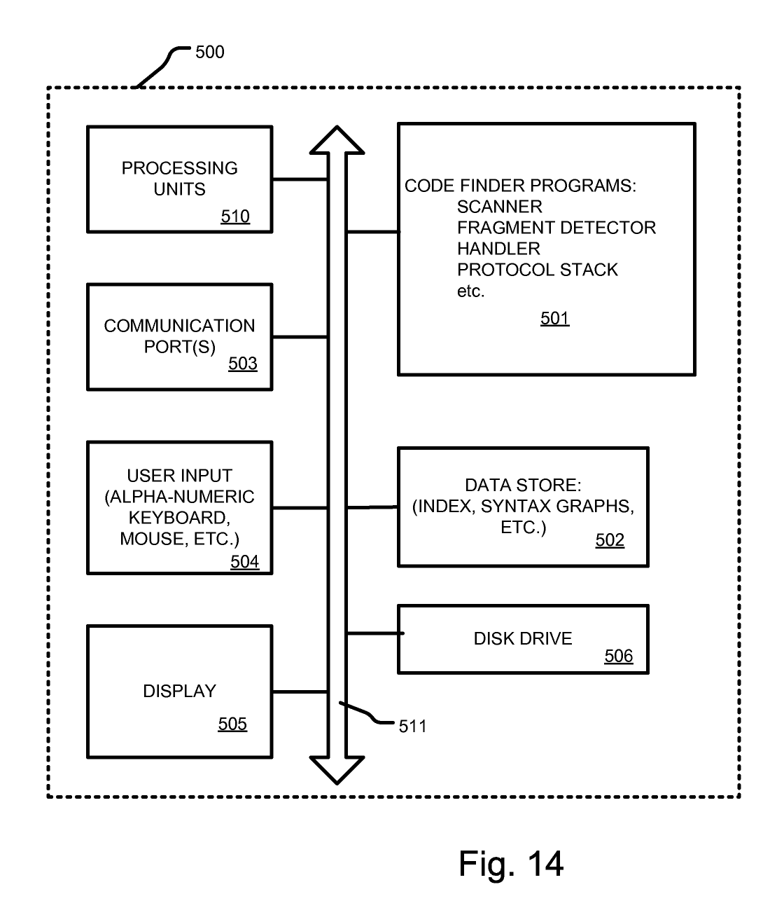

FIG. 14 is a simplified block diagram of a data processing system 500 including a code finder system, like device 14a with module 14b in FIG. 1. The system 500 includes one or more processing units 510 coupled to a bus or bus system 511. The processing units 510 are arranged to execute computer programs stored in program memory 501, access a data store 502, access large-scale memory such as a disk drive 506, to control interfaces including communication ports 503, user input devices 504, audio channels (not shown), etc. and to control a display 505. The data store 502 includes indices, syntax graphs, buffers and so on. The device as represented by FIG. 6 can include for examples, a network appliance, a computer workstation, a mobile computing device, and networks of computers utilized for Internet servers, proxy servers, network intermediate devices and gateways.

The data processing resources include logic implemented as computer programs stored in memory 501 for an exemplary system, including a scanner, a parser and a communications handler. In alternatives, the logic can be implemented using computer programs in local or distributed machines, and can be implemented in part using dedicated hardware or other data processing resources.

An article of manufacture comprising a non-transitory machine readable data storage medium, such as an integrated circuit memory or a magnetic memory, can include executable instructions for a computer program stored thereon, the executable instructions comprising:

logic to buffer a data flow received at an interface;

logic to scan the data flow to detect well-formed code fragments expressed in at least one computer readable programming language;

logic to process the detected fragments; and

logic to forward the data flow from the buffer to a destination.

The logic to scan the data flow implemented by executable instructions in the article of manufacture, detects tokens that represent candidate code elements, and including logic to parse the tokens in the data flow according to a syntax graph stored in a data structure, the syntax graph encoding a syntax for a computer programming language, to identify sequences of candidate code elements which satisfy the syntax graph. The syntax graph data structure encodes syntaxes for a plurality of programming languages. Also, in the article of manufacture, the memory can store the indexed syntax graph.

Rather than attempt to approximate an answer to the question of whether some given input contains shell code, a code finder system as described herein can take advantage of the fact that both executable and interpreted code are designed to be machine readable. Similarly, a code finder system as described herein takes advantage of the fact that well-formed code is difficult to construct. When compared to unstructured user input or most data formats, the likelihood of the accidental presence of well-formed code is infinitesimal. In short, a code finder system as described herein can be configured to deterministically and definitively recognize the presence of shell code within a data flow used to provide system input with minimal risk of misidentification.

Also, a code finder system need not be concerned with unambiguously differentiating a particular statement from another statement. Since statements are not translated and executed by the code finder system, intra- or inter-language ambiguity is not a factor in some embodiments. In these embodiments recognition logic can be simplified, as any match is sufficient to invoke processing of a suspected code fragment.

A code finder system is described that can recognize multiple programming languages simultaneously. This, when combined with the inherent structured nature of machine readable programming languages, enables recognition to occur quickly enough to be useful for monitoring data flows in a communications channel.

A code finder system may be deployed as a software module, a web service or as part of a larger security system. For a data flow that is expected to be free of executable or interpreted code, or free of one or more known styles of executable or interpreted code, the code finder system can be deployed to protect participants in the communications network from undesired code. Examples of payload carried by data flows that can be monitored include, but are not limited to, user input data provided as part of interacting with a web application, data files or entities, such as images or videos, and user input data provided as part of interacting with a desktop application.

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

What is claimed is:

1. A method, comprising:
monitoring a data flow received at a data processing system to detect fragments of well-formed code that consist of incomplete statements or expressions expressed in at least one computer readable programming language including fragments that do not have starting tokens determined before receiving the data flow; and
processing the detected fragments.

2. The method of claim 1, including removing the detected fragments from the data flow.

3. The method of claim 1, including logging and reporting the detected fragments.

4. The method of claim 1, the monitoring including scanning the data flow to detect said well-formed code fragments in a plurality of computer readable programming languages.

5. The method of claim 1, wherein the monitoring detects fragments that do not include both starting and ending tokens determined before receiving the data flow.

6. The method of claim 1, wherein the monitoring includes identifying fragments that include viable prefixes of tokens or of sequences of tokens in the data stream.

7. The method of claim 1, including buffering the data flow during said monitoring.

8. The method of claim 1, including buffering the data flow during said monitoring, removing or modifying the detected fragments in the data flow.

9. A method, comprising:
scanning a data flow in a communication channel to detect tokens that represent candidate code elements in a plurality of programming languages;
processing the tokens in the data flow to identify sequences of candidate code elements, including sequences that consist of incomplete statements or expressions, of well-formed code in the plurality of programming languages; and
processing the identified sequences.

10. The method of claim 9, wherein said processing the tokens includes using an index based on candidate code elements to access a syntax graph data structure.

11. The method of claim 9, including removing the identified sequences from the data flow.

12. The method of claim 9, including logging and reporting the identified sequences.

13. The method of claim 9, including using a syntax graph data structure that encodes syntaxes for the plurality of programming languages.

14. The method of claim 9, wherein the scanning detects sequences that do not include both starting and ending tokens determined before receiving the data flow.

15. The method of claim 9, wherein the scanning includes identifying sequences that include viable prefixes of tokens or of sequences of tokens in the data stream.

16. The method of claim 9, including buffering the data flow during said processing the tokens and the identified sequences, and releasing the data flow after said processing.

17. The method of claim 9, including buffering the data flow during said processing the tokens and the identified sequences, removing or modifying the identified sequences in the payload, and releasing the data flow after said removing or modifying.

18. The method of claim 9, wherein said processing the identified sequences includes removing the identified sequence from the data flow, to form a modified data flow, and repeating the scanning and processing steps over the modified data flow until no sequences are identified or a threshold number of passes has been met.

19. A data processing system, comprising:
an interface, and data processing resources coupled to the interface including executable instructions, the data processing resources including:
logic to buffer a data flow received at the interface;
logic to scan the data flow to detect fragments of well-formed code that consist of incomplete statements or expressions expressed in at least one computer readable programming language including fragments of well-formed code that do not have starting tokens determined before receiving the data flow;
logic to process the detected sequences; and
logic to forward the data flow from the buffer to a destination.

20. The data processing system of claim 19, wherein the logic to scan the data flow detects tokens that represent candidate code elements, and logic to parse the tokens in the data flow according to a syntax graph data structure, the syntax graph encoding a syntax for a computer programming language, to identify said fragments of candidate code elements which satisfy the syntax graph.

21. The data processing system of claim 20, wherein the syntax graph data structure encodes syntaxes for a plurality of programming languages.

22. The data processing system of claim 20, including memory storing the indexed syntax graph data structure.

23. The data processing system of claim 20, including an index accessible to the data processing resources, the index mapping candidate code elements to the syntax graph data structure.

24. The data processing system of claim 19, wherein the logic to process detected sequences removes the detected sequences from the buffered data flow.

25. The data processing system of claim 19, wherein the logic to process detected sequences logs the detected sequences.

26. The data processing system of claim 19, wherein the logic to scan the data flow to detect fragments of well-formed code is configured to detect fragments that do not include both starting and ending tokens determined before receiving the data flow.

27. The data processing system of claim 19, wherein the logic to scan the data flow to detect fragments of well-formed code is configured to identify viable prefixes of tokens or of sequences of tokens in the data stream.

28. The data processing system of claim 19, wherein said logic to process removes the identified fragment from the data flow, to form a modified data flow, and iteratively applies the logic to scan the data flow using the modified data flow until no well-formed code fragments are identified or a threshold number of scans has been executed.

29. An article of manufacture comprising a non-transitory machine readable data storage medium, and executable instructions for a computer program stored thereon, the executable instructions comprising:
logic to buffer a data flow received at an interface;
logic to scan the data flow to detect fragments of well-formed code that consist of incomplete statements or expressions expressed in at least one computer readable programming language including fragments of well-formed code that do not have starting tokens determined before receiving the data flow;
logic to process the detected fragments; and
logic to forward the data flow from the buffer to a destination.

30. The article of claim 29, wherein the logic to scan the data flow detects tokens that represent candidate code elements, and including logic to parse the tokens in the data flow according to a syntax graph data structure, the syntax graph encoding a syntax for a computer programming language, to identify fragments of candidate code elements which satisfy the syntax graph.

31. The article of claim 29, wherein the logic to scan the data flow to detect fragments of well-formed code is configured to detect fragments that do not include a known starting token.

32. The article of claim 31, wherein the logic to scan the data flow to detect fragments of well-formed code is configured to identify viable prefixes of tokens or of sequences of tokens in the data stream.

33. The article of claim 29, wherein said logic to process removes the identified fragment from the data flow, to form a modified data flow, and iteratively applies the logic to scan the data flow using the modified data flow until no well-formed code fragments are identified or a threshold number of scans has been executed.
